(19) United States
(12) Patent Application Publication
(10) Pub. No.: US 2026/0264857 A1
(43) Pub. Date: Sep. 10, 2026

(54) AIRCRAFT CONFIGURATION CHANGE KIT

(71) Applicant: L. H. COLUS TECNOLOGIA LTDA, São José dos Campos (BR)

(72) Inventors: Pedro LUIZ GOLOBOVANTE LOUREIRO, São José dos Campos (BR); Luís HENRIQUE MÉDICI COLUS, São José dos Campos (BR)

(21) Appl. No.: 19/163,230

(22) PCT Filed: Mar. 8, 2024
(86) PCT No.: PCT/BR2024/050083

§ 371 Date: Sep. 8, 2025

(30) Foreign Application Priority Data
Mar. 8, 2023 (BR) 2020230043238

(51) Int. Cl. B64D 9/00; B64D 45/00

(52) U.S. Cl. CPC B64D 9/003; B64D 2045/009

(57) ABSTRACT

This utility model concerns a kit that allows for the quick transition of passenger aircraft (PAX) configuration to the Cargo Quick Change Class F configuration through the incorporation of exclusive elements. More specifically, the invention relates to innovative technologies implemented in the aircraft conversion process, including a Cargo Net (1) composed of a braided mesh (2) of polyester tape, treated with flame retardant, and a Fire Containment Coating (3) made of flame-retardant fabric; a Smoke Barrier consisting of a “curtain” of polyurethane fabric (10) that meets the flammability requirements of 14 CFR 25.853 (a) of Amendment 25-116 and optionally includes at least one transparent viewport (11). Additionally, the kit comprises a fire detection system, which includes at least two Infrared Thermal Cameras (14), with a Control Panel equipped with the UAF Alarm System (15).

This utility model concerns a kit that allows for the quick transition of passenger aircraft (PAX) configuration to the Cargo Quick Change Class F configuration through the incorporation of exclusive elements. More specifically, the invention relates to innovative technologies implemented in the aircraft conversion process, including a Cargo Net (1) composed of a braided mesh (2) of polyester strips, treated with flame retardant, and a Fire Containment Coating (3) made of flame-retardant fabric; a Smoke Barrier consisting of a “curtain” of polyurethane fabric (10) that meets the flammability requirements of 14 CFR 25.853 (a) of Amendment 25-116 and optionally includes at least one transparent viewport (11). Additionally, the kit comprises a fire detection system, which includes at least two Infrared Thermal Cameras (14), with a Control Panel equipped with the UAF Alarm System (15).

Due to the COVID-19 pandemic, it was allowed by ANAC, through resolution No. 600 dated Dec. 15, 2020, for airlines to carry cargo in the cabin on an exceptional and temporary basis. However, the issuance of the Supplemental Type Certificate (STC) for a Class F cargo compartment enables the transportation of a larger volume of cargo, besides not being limited by the conditions of the resolution and can be used independently of the exceptional situation brought about by the pandemic.

The certification of an aircraft in the cargo categorization Class F, through the Supplemental Type Certificate (STC), allows it to transport cargo in the passenger cabin, in containers resistant to heat and fire, with a fire detection system through thermal cameras.

The modification of ERJ-190-100/200 aircraft from Passenger Transport Configuration to Quick Change Cargo Configuration Class F aims to allow that, from the incorporation of the CST, the aircraft can be converted in a short period of time.

The incorporation of the CST consists of the permanent installation of some provisions that are used for this rapid conversion. From the aircraft with the provisions installed, for changing the configuration of its floor, the following systems/equipment are removed:
All passenger seats, along with their respective Entertainment System Video-Display Units (VDU);
Emergency Chemical Oxygen Generators, from the PSU of passenger positions and from the rear Galey and toilet positions;
Emergency Oxygen Masks, from the PSU of passenger positions and from the rear Galey and toilet positions;
The rear toilet door.
Rear partitions with emergency accessories and equipment installed on them;
Emergency equipment installed in the Overhead Bins;
Rear Galey equipment (Trolleys, Ovens, Coffee Makers, Water Boilers, and the Wheelchair) and emergency equipment (PBE, Fire Extinguishers);
The upper central compartment hatch in the rear galley, with its hinge;
The front Galey trolleys.
The Filler next to the Left Side Lining Panel, position 225 HLW.
The Flight Attendant Instruction light panel on the Front Ceiling Interface Panel.

After removal, the Kit developed in this invention is installed, essentially composed of sets of Cargo Net, a fabric Smoke Barrier, and a Fire Detection System with two Infrared Sensor Cameras.

Reconversion to Passenger Transport involves removing the Cargo Net sets, the Smoke Barrier, and the Fire Detection System, followed by the reinstallation of the necessary equipment and parts for passenger transport.

This Kit allows the aircraft to be converted as needed by the operator, making its use more flexible in response to market demand.

In searches conducted in patent databases, documents protecting fire containment structures, cargo nets containing strips, and fire detection systems for aircraft application were found. For instance, patent document U.S. Pat. No. 5,540,402A, titled “Cargo conversion system for passenger aircraft,” presents a configuration applied in aircraft comprising a barrier for smoke, flames, and volatile materials. This barrier (98) is formed by rigid plates mounted along the internal compartment section of the fuselage and fits through fitting devices mounted with seals (72). This technology does not mention the possibility of rapid reversibility between cargo and passenger transport modes. Patent document U.S. Pat. No. 5,540,402A, with a priority date of Aug. 11, 1993, also titled “Cargo conversion system for passenger aircraft,” presents a cargo net sized to delimit the entire section of the aircraft's internal compartment. The net has fixing means on the floor rail (46), features a rectangular mesh (58), and does not delimit a closed volume. Patent document U.S. Pat. No. 6,302,358B1, titled “Quick Change system and method for converting an aircraft from a cargo mode to a passenger mode and vice versa,” presents improvements consisting of an arrangement for fixing an assembly intended to house a load inside a generic aircraft for cargo transport configuration. Essentially, the technology proposes means of fixing a pallet (7) on a floor (5) using fixing means (18,21,45,6). The pallet (7) is capable of securing a generic load through fixing means (11,12).

However, through the searches, no technologies compromising the novelty and inventive activity of the present invention were found. It is evident that the technical elements of the structures present in our invention's Kit were specially adapted and applied to solve cargo transport in aircraft with fire/smoke containment means and to solve the technical problem of reversibility between cargo and passenger transport modes, without the need for pallets and structural modification of the aircraft.

### BRIEF DESCRIPTION OF THE FIGURES

FIG. 1 shows the Cargo Net (1) with the woven mesh (2) of Polyester strips, the Fire Containment Coating (3), the double pin fastener (4), and the hooks (5).

FIG. 2 shows the Cargo Net (1) with the woven mesh (2) of Polyester Strips, the Fire Containment Coating (3), the double pin fastener (4), the hooks (5), the closing covers (6), the touch fasteners (7), the internal tubular metal frame (8), and the external closure (9).

FIG. 3 shows the Smoke Barrier with the fabric “curtain” (10) in polyester fabric and the transparent pannel (11).

FIG. 4 shows the Smoke Barrier (10) fixed to the ceiling by fabric brackets (12) with touch fasteners, previously attached to the central ceiling panel.

FIG. 5 shows the fabric bracket (12) for fixing the Smoke Barrier (10) to the ceiling, the metal bars wrapped in fabric (13) for its attachment to the side and floor.

FIG. 6 shows independent parts of the Smoke Barrier (10) installed in the openings of the two rear back partitions.

FIG. 7 shows the coverage area of the infrared thermal cameras (14), front (A) and rear (B), of the fire detection system.

FIG. 8 shows the infrared thermal cameras (14) and the fire alarm unit (UAF) (15), containing the light indicators (16), audible alarm (17), and cut-off button (18).

FIG. 9 shows the signaling placards of the cargo net positions (19), lateral boundaries (20), upper and weight limits of each net (21), and the identifier of the fire detection system circuit breakers (22).

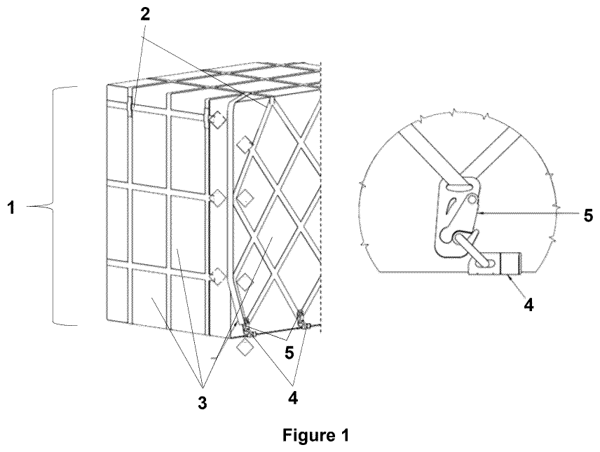

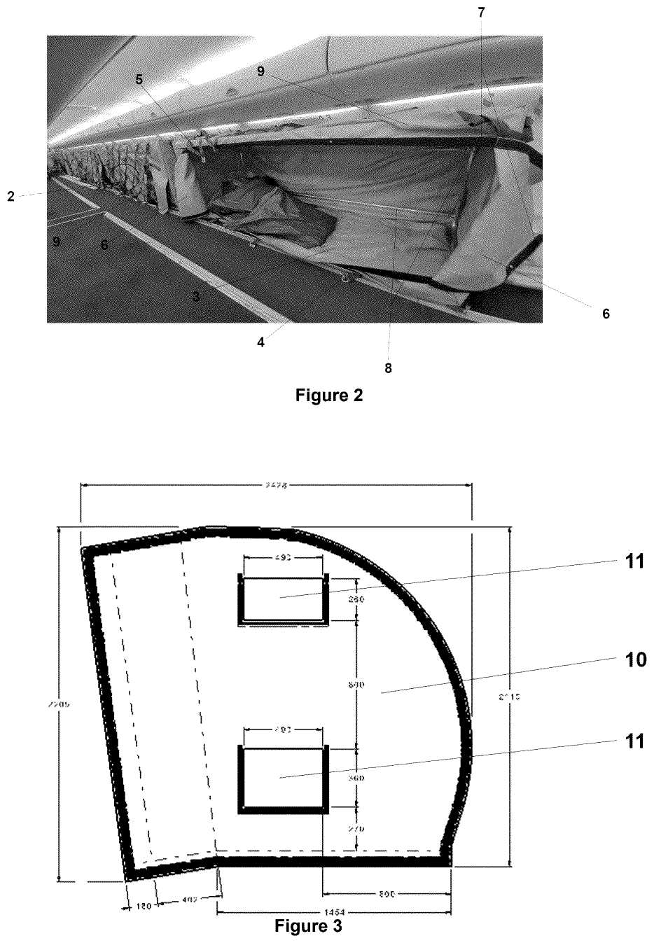

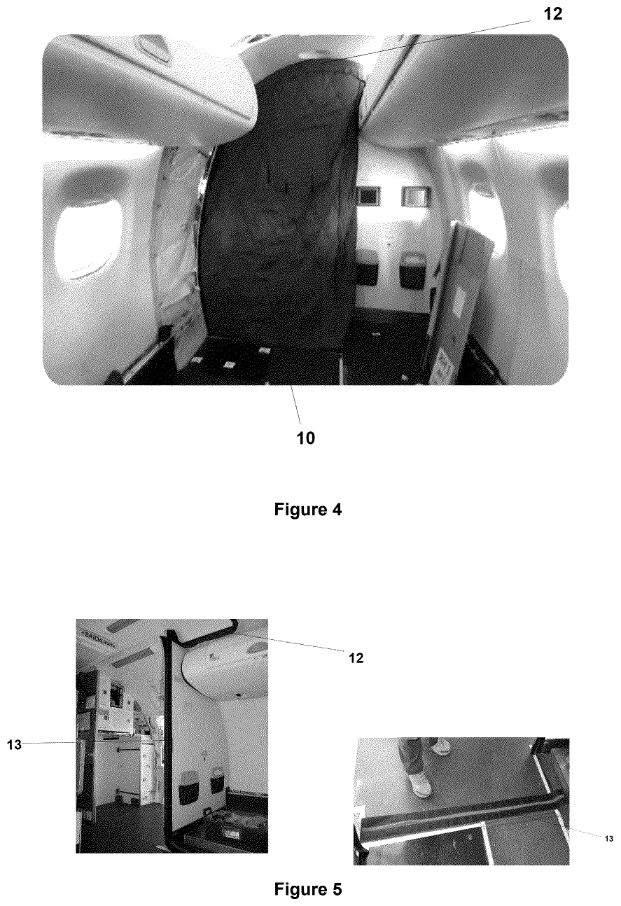

### DETAILED DESCRIPTION OF THE INVENTION

The present invention is a Kit for the rapid conversion of a PAX aircraft to a Quick Change Class F Cargo aircraft.

The Kit comprises at least one Cargo Ne (1)t, a Smoke Barrier, and a Fire Detection System.

The Cargo Net (1) is composed of a woven mesh (2) of of Polyester strips, treated with flame retardant. It features a Fire Containment Coating (3) made of flame-resistant fabric. Its attachment to the aircraft floor is through internal rails, near the aisle, using double pin fasteners (4) to which hooks (5) are attached, secured at each vertex of the woven mesh (2), and through external rails, near the windows, using double pin fasteners (4) secured to the woven mesh (2). The front face consists of two closing covers (6) with touch fasteners (7) (commonly known as “velcro”), through which loading and unloading occur. The combination of internal and external covers, with openings in perpendicular directions, ensures fire-tight closure. Internal closure begins with the attachment of touch fasteners (7) surrounding the entire opening. An internal tubular metal frame (8), mounted inside the cargo net, keeps it in the open position, facilitating loading and unloading operations. The external closure (9), sewn at the top, covers the entire front region of the Cargo Net, forming a second fire protective barrier in that region.

The double pins (4), which secure the net mesh to the aircraft rails, enable it to withstand the emergency loads required to meet the emergency landing requirements for Class F cargo compartments (14 CFR 25.561 of Amdt. 25-91). The weight of each Fire-Resistant Cargo Net is approximately 20 kg.

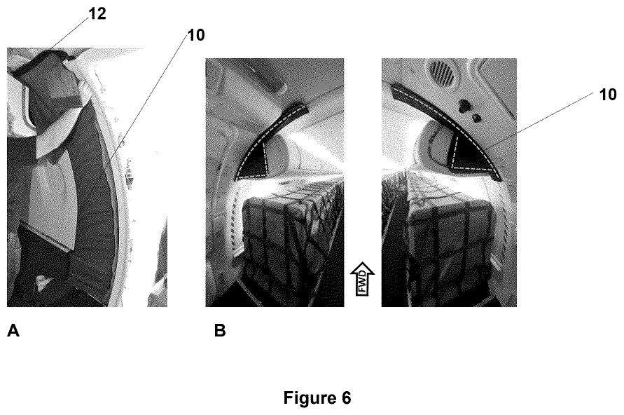

The Smoke Barrier consists of a fabric “curtain” (10) sewn in two layers and optionally includes at least one transparent pannel (11). Its attachment to the ceiling is through fabric brackets (12) with touch fasteners, previously attached to the central ceiling panel. In the front right divider, located just after the service door, attachment is done using the metal bars wrapped in fabric (13) with touch fasteners, and the same applies to the floor, for hem closure. The Smoke Barrier also includes three independent parts to be installed in the open spaces of the liner (FIG. 6A), due to the removal of the left front monument and in the opening of the two rear partitions (FIG. 6B).

The material used in manufacturing the Smoke Barrier was pre-qualified according to 14 CFR 25.853 (a) of Amdt. 25-116.

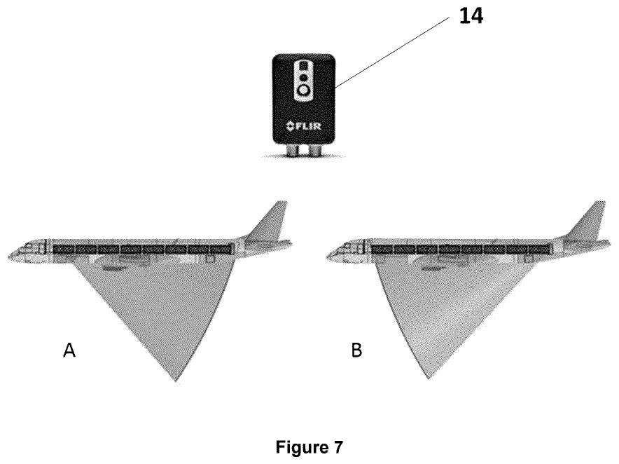

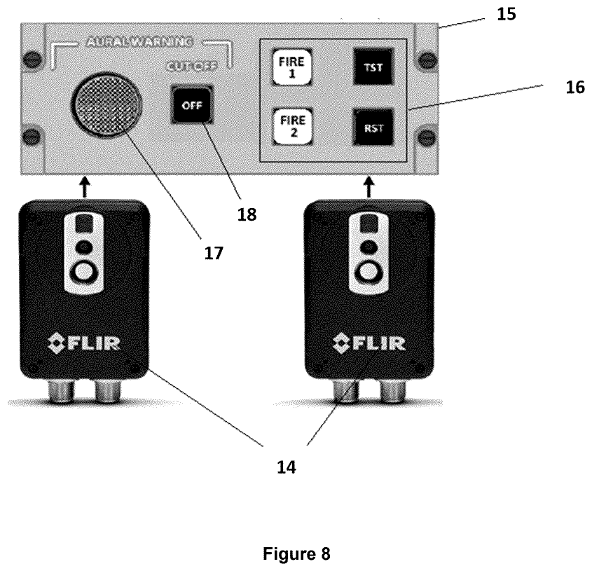

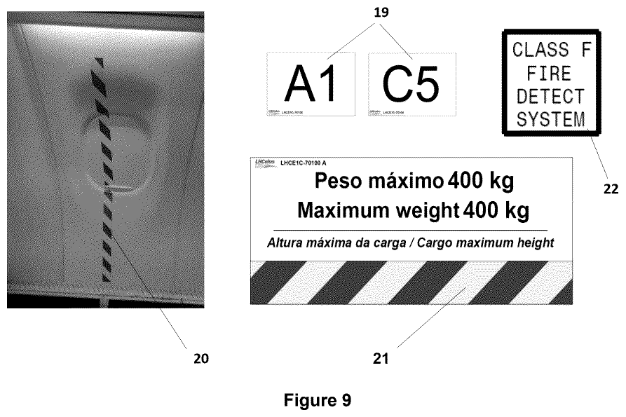

The Fire Detection System comprises at least two Infrared Thermal Cameras (14), with the first installed in the front portion (FIG. 7A) with a view towards the rear portion of the aircraft and the second installed in the rear portion of the aircraft with a view towards the front portion (FIG. 7B) to cover the entire cargo compartment cabin. This system has a Control Panel with a UAF Alarm System (15) for the crew, installed in the rear portion of the Pedestal Panel near the Pilot's position, on the side of the printer, in the Cockpit. The Control Panel with Alarm System includes light indicators (16), audible alarm (17), and cut-off button (18).

Unlike conventional smoke detection systems, the infrared cameras are configured to provide an alarm signal if they detect signs of a fire start, even before it evolves into a large fire and produces smoke resulting from combustion.

Vinyl IJ180MC 3M Placards are installed to signal the positioning of the nets (19), lateral boundaries (20), upper and weight limits of the load (21), as well as the circuit breakers of the fire detection system (22). The placards will be arranged, for each net on each side, throughout the compartment and will be removed when returning to the passenger configuration. The following Emergency Equipment is relocated to the Front Galley:
Two Halon Fire Extinguishers;
Two PBEs (Portable Breathing Equipment);
One First Aid Kit;
One Jungle Survival Equipment Set.

Reconversion to Passenger Transport removes the Cargo Net sets, the Smoke Barrier, and the Fire Detection System, returning with the necessary equipment and parts for passenger transport.

The modification will allow the aircraft to be converted as deemed necessary by the aircraft operator, making its use more flexible according to market demand.

1. A kit for changing a cargo configuration in an aircraft, the kit comprising:
at least one cargo net comprising:
a woven mesh treated with flame retardant and comprising a plurality of vertices;
a fire containment coating made of flame-resistant fabric;
hooks attached to each vertex of the plurality of vertices and configured to couple to double pin fasteners secured on external rails of the aircraft and attach the cargo net to the aircraft;
two closing covers disposed on a front face of the cargo net via touch fasteners that surround an opening of the cargo net; and
an external closure sewn at a top of the cargo net and configured to cover-a front region of the cargo net;
at least one smoke barrier comprising:
a fabric curtain comprising two layers and at least one transparent viewport;
at least one fabric bracket with touch fasteners configured to attach the smoke barrier to a ceiling of the aircraft; and
at least one metal bar wrapped in fabric and comprising touch fasteners configured to attach the fabric curtain to the aircraft;
at least one Fire Detection System-fire detection system comprising:
at least two infrared thermal cameras; and
at least one control panel with one or more UAF alarm system light indicators, an audible alarm, and a cut-off button; and
one or more placards comprising at least one indicator configured to signal a positioning of nets, lateral boundaries, upper and lower weight limits of a cargo load, and circuit breakers of the at least one fire detection system.

2. The kit of claim 1, wherein the woven mesh is made of polyester with flame retardant treatment.

3. The kit of claim 1, wherein the fabric curtain of at least one smoke barrier complies with 14 CFR 25.853 (a) da Amdt. 25-116.

4. The kit of claim 1, wherein the at least one smoke barrier comprises at least three parts to be installed in open spaces of the aircraft to accommodate, removal of a left front monument of the aircraft and two rear partitions of the aircraft.

5. The kit of claim 1, wherein the at least one cargo net further comprises an internal tubular metal frame mounted inside the cargo net and configured to keep the cargo net in an open position.

6. The kit of claim 1, wherein the one or more placards comprise vinyl placards.
